(19) United States
(12) Patent Application Publication
(10) Pub. No.: US 2009/0052442 A1
(43) Pub. Date: Feb. 26, 2009

(54) AUTOMATICALLY ROUTING SESSION INITIATION PROTOCOL (SIP) COMMUNICATIONS FROM A CONSUMER DEVICE

(75) Inventors: LI-JU CHEN, TAIPEI (TW); YING-CHEN YU, TAIPEI (TW)

Correspondence Address: PATENTS ON DEMAND, P.A. - IBM Lotus, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 11/841,220

(22) Filed: Aug. 20, 2007

(51) Int. Cl. H04L 12/28

(52) U.S. Cl. 370/389

(57) ABSTRACT

The present invention discloses a Session Initiation Protocol (SIP) Message Automatic Routing Technique (SMART) device that includes a unique identifier and a SMART engine. The unique identifier can be used by an SIP based communication server as a communication endpoint, which means that the unique identifier for the SMART device is used by an SIP server to route communication requests to the SMART device. The SMART engine can forward received SIP messages to other communication devices in a manner transparent to the SIP based communication server. In one embodiment, the SMART device can be a consumer communication device, such as a computer having soft phone software installed, a mobile telephone, or an SIP enabled communication device.

### BACKGROUND

1. Field of the Invention

The present invention relates to the field of session initiation protocol (SIP) communications and, more particularly, to routing SIP communications using end-user devices that receive SIP messages from an SIP server.

2. Description of the Related Art

Session Initiation Protocol (SIP) is an application-layer control protocol for establishing, modifying, and terminating multimedia sessions with one or more participants. The types of sessions include Internet telephony, multimedia distribution, and multimedia conferences. An SIP user is given the option to register more than one address. Such addresses can be phone numbers, email addresses, and the like. Currently, when a user receives an SIP request and has multiple addresses registered, each address receives the same request. Once a device responds to the request, the subsequent messages are routed to only that device.

Users often have preferences to which devices receive which kind of SIP requests. Their preferences can even change depending on variable conditions, such as a type of communication. For example, a user can prefer to have text exchange (e.g., Instant Message, chat, and text message) communications sent to a computer and Internet protocol (IP) telephony communications directed to a Voice over Internet Protocol (VoIP) phone. Currently, no solution exists for automatically routing Session Initiation Protocol (SIP) messages from a consumer device which is registered with an SIP server.

### SUMMARY OF THE INVENTION

The present invention discloses automatically routing Session Initiation Protocol (SIP) communications. This enhancement allows users to automatically route incoming SIP messages from an original message receiving device, which can be an SIP Message Automatic Routing Technique (SMART) device, to preferred devices or other deterministic conditions. More specifically, the SMART device can route SIP communications to auxiliary devices registered with the SMART device. This can significantly reduce a quantity of transactions that are handled by an SIP server, while still ensuring SIP messages are routed to desired end-devices. Currently, when a user has multiple SIP-enabled addresses registered on a registrar server and the user receives an incoming SIP communication, the SIP Server can route the SIP communication to each of the registered addresses. SMART enabled devices reduce the number of messages sent from the SIP Server by storing the user's routing preferences in the SMART enabled device, which performs secondary routing—primary routing being handled by the SIP Server. Accordingly, the SIP Server can send a single SIP communication to the SMART enabled device and SMART can route the communication to the user's preferred device.

The present invention can be implemented in accordance with numerous aspects consistent with the material presented herein. For example, one aspect of the present invention can include a method for communicating in an IP based system comprising a registrar server. The method can include a step of registering a primary address of a primary device (e.g., a SMART device) with a registrar server. The primary device can include a routing engine. The registrar server can be part of an IP based communication system. A set of user configurable routing characteristics can be maintained in a data store accessible by the primary device, which is used by the routing engine. At least one auxiliary address of at least one auxiliary device can be registered with the primary device which results in the auxiliary address being added to the data store accessible by the primary device. A communication request directed from an originating device to the primary device can be received, which the SIP server routes to the primary device based upon the registered primary address. Upon receiving the routed communication request, the routing engine of the primary device can forward the communication request to one of the auxiliary devices based upon the registered auxiliary addresses and based upon the maintained routing characteristics.

Another aspect of the present invention can include a SMART device that includes a unique identifier and a SMART engine. The unique identifier can be used by an SIP based communication server as a communication endpoint, which means that the unique identifier for the SMART device is used by a registrar server to route communication requests to the SMART device. The SMART engine can forward received SIP messages to other communication devices in a manner transparent to the SIP based communication server.

Still another aspect of the present invention can include an SIP based communication system including a communication originating device, a registrar server, an SIP server, a SMART device, and a communication receiving device. The communication originating device can originate an SIP communication. The SIP server can receive SIP communication origination messages and can match these origination messages to registered device addresses. One of these addresses can be an address for the SMART device. The SMART device can receive SIP requests from the SIP server and can route SIP requests to other devices. These other devices can be associated with device addresses in accordance with a set of deterministic conditions and configurable routing preferences. One of devices designated by the SMART device routing preferences can be referred to the communication receiving device. The communication receiving device can receive an SIP request routed to the receiving device by the SMART device, which routed the SIP message from the SIP server, which received a communication initiation request from the communication originating device. When the communication receiving device accepts the received SIP request, an SIP based communication can be established between the communication receiving device and the communication originating device.

It should be noted that various aspects of the invention can be implemented as a program for controlling computing equipment to implement the functions described herein, or as a program for enabling computing equipment to perform processes corresponding to the steps disclosed herein. This program may be provided by storing the program in a magnetic disk, an optical disk, a semiconductor memory, or any other recording medium. The program can also be provided as a digitally encoded signal conveyed via a carrier wave. The described program can be a single program or can be implemented as multiple subprograms, each of which interact within a single computing device or interact in a distributed fashion across a network space.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram illustrating a system that is capable of automatically routing Session Initiation Protocol (SIP) communications in accordance with an embodiment of the inventive arrangements disclosed herein.

FIG. 2 is a flow diagram illustrating use of a SMART device to route incoming messages based on content type in accordance with an embodiment of the inventive arrangements disclosed herein.

FIG. 3 is a schematic diagram illustrating a system for automatically routing SIP communications based on the end-user location in accordance with the embodiment of inventive arrangements disclosed herein.

FIG. 4 is a schematic diagram illustrating an interface that can be used to manage preferred routing settings of a SMART device in accordance with an embodiment of the inventive arrangements disclosed herein.

FIG. 5 is a flow chart of a method of automatically routing SIP communications in accordance with an embodiment of the inventive arrangements disclosed herein.

FIG. 6 is a flow chart of a method of automatically routing SIP communications using a SMART device in accordance with an embodiment of the inventive arrangements disclosed herein.

### DETAILED DESCRIPTION OF THE INVENTION

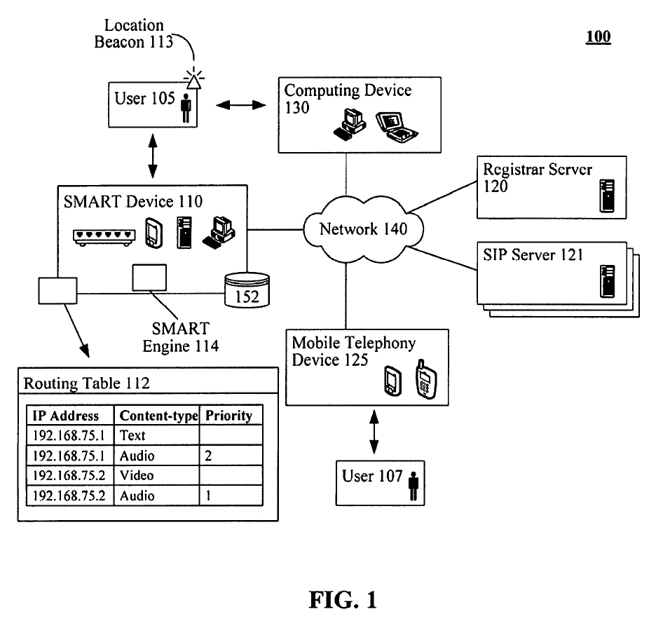

FIG. 1 is a schematic diagram illustrating a system 100 that is capable of automatically routing Session Initiation Protocol (SIP) communications in accordance with an embodiment of the inventive arrangements disclosed herein. The SIP Message Automatic Routing Technique (SMART) enabled device 110 distinguishes system 100 from a conventional SIP communication system. More specifically, a conventional system of communicating using SIP messages requires registration of addresses for SIP enabled devices within a registrar server. Multiple device addresses can be registered for a message endpoint designator, which can be a user-associated designator. A message endpoint designator can, for example, be a phone number associated with one or more Voice over IP (VoIP) phones, which are each associated with an SIP device address. Messages directed toward the endpoint designator can be routed by an SIP server 121 to every registered SIP device address associated with the endpoint designator.

The disclosed inventive arrangements shown in system 100 reduce the messages handled by an SIP server 121, and thereby reduce network 140 traffic by permitting the SMART device 110 to perform secondary message routing operations. The SMART device 110 can store the up-to-date information and use it to automatically route SIP messages in accordance with a set of configurable rules. The SMART device 110 can enable a user 105 to establish a profile with preferred devices for different SIP content types, which can be determined from SIP header. Such content types can include, but are not limited to, Internet telephony communications, multimedia distribution, instant message communications, text messaging, and the like. These content types can be decomposed into subtypes, which can be used to designate which end devices messages are to be selectively routed to.

More specifically, in system 100, the SMART device 110 can send a REGISTER request to the registrar server 120. Then, the user 105 can configure routing preferences of the SMART device 110. For example, the SMART device 110 can include an interactive interface, which the user 105 can utilize. In another example, configuration of SMART device 110 can occur using a different device 130 connected to device 110 via network 140 or via a local communication port (e.g., USB or serial port) connecting devices 110 and 130. SMART enabled device 110 can maintain information related to the routing preferences in data store 152. Additionally, SMART enabled device 110 can use SMART engine 114 to automatically route SIP communications to preferred devices based on the established routing preferences. The configurable rules and conditions used for SMART message routing can be of any arbitrary level of complexity, as long as deterministic conditions for routing are able to be programmatically established and executed by a computing device 110. A configurable routing table 112 can be contained within an accessible data store 152 which is used to store routing preferences. In one contemplated embodiment, different types of content, such as voice, text, music, and video can be routed to different end-devices in accordance with settings of routing table 112.

The SMART enabled device 110 can be able to handle situational conditions, which would be overly burdensome for an SIP server 121 to handle. These situational conditions can include dynamic conditions, such as a user's 105 location, which can effect message routing. For example, the SMART enabled device 110 can include a set of location-based routing preferences, which can be used in conjunction with available state information (e.g., a user's location as established by a location beacon 113 for example), to determine appropriate devices 130, 125 to which incoming SIP messages originating from SIP server 121 are to be conveyed.

Hence, in one implementation, the SMART device 110 bases routing, at least in part, upon user 105 location, which can be determined by location beacon 113. For example, the SMART device 110 can route messages to an office computer 130 when the user 105 is geographically located in a related office and can route messages to a different communication device 125, when the user 105 is at home. In another example, the smart-enabled device 110 can route messages to a mobile telephony device 125 of a different user 107, such as a business partner, when a user 105 is in a conference room. Further, the SMART device 110 itself can be a communication device, which is able to permit user 105 to communicate with others over network 140. In one embodiment, the location beacon 113 can be integrated within the SMART device 110. For example, the SMART device 110 can be a GPS equipped (beacon 113) mobile phone carried by the user 105. In another embodiment, the location beacon 113 that tracks the user's location can be implemented in a set of devices distinct form device 110, yet which are able to convey location determination data to the SMART device 110. Use of user 105 location information to route communications is just one example of a dynamic condition, which the SMART device 110 can use and the invention is not to be construed as limited in this regard.

In system 100, the SMART device 110 can be any consumer device having a unique address, which can be registered in the registrar server 120. The SIP server 121 can treat the SMART device 110 as an SIP communication endpoint. The SMART device 110 can function as an SIP communication endpoint and/or can function as an SIP communication router. The SMART device 110 can be implemented in numerous fashions. In one embodiment, the SMART device 110 can be an SIP enabled communication device, such as a smart phone, which has been enhanced to add SMART routing capabilities. In another embodiment, the SMART device 110 can be a computer including a software application that executes the functions of the SMART engine 114. In still another embodiment, the SMART device 110 can be a consumer device connected to a home communication system, which selectively routes incoming SIP communications in accordance with configurable settings. For example, the SMART device 110 can be a dedicated consumer electronic device able to be connected to a home computer network via an Ethernet capable or WiFi transceiver. In another example, the SMART device 110 can be implemented within an Ethernet hub or router, which has been enhanced over conventional hubs and routers to include a SMART engine 114. In yet another embodiment, the SMART device 110 can be a computer peripheral able to be linked to a networked computer via a USB cable, a BLUETOOTH link, or other peripheral interface.

Location beacon 113 can include any number of cooperating components, which together can be used to determine a location of the user 105. In various embodiments, the location beacon 113 can include a Radio Frequency Identification (RFID) tag, a Global Positioning System (OPS) transceiver, a BLUETOOTH transceiver, a WIFI (i.e., adhering to any of the 802.11 family of protocols) transceiver, and other such devices.

For example, the location beacon 113 can include an RFID tag embedded within a device commonly carried by user 105, such as a user's name tag, a parking pass, a keychain, a wallet card, a driver's license, and the like. When a location beacon 113 includes an RFID tag, a series of RFID scanners can be strategically positioned so that locations of user 105 carried RFID tags can be determined.

In another example, a short distance transceiver can be used as a location beacon 113. Short distance transceivers include BLUETOOTH transceivers, cellular transceivers, and wireless network transceivers (802.11 compliant protocols). Additionally, triangulation techniques can optionally be used to determine a location of a signal emitting/receiving device, used as a location beacon 113.

The data store 152 can be physically implemented within any type of hardware including, but not limited to, a magnetic disk, an optical disk, a semiconductor memory, a digitally encoded plastic memory, or any other recording medium. Data store 152 can be a stand-alone storage unit as well as a storage unit formed from a plurality of physical devices which may be remotely located from one another. Additionally, information can be stored within the data store 152 in a variety of manners. For example, information, such as table 112 information, can be stored within a database structure or can be stored within one or more files of a file storage system where each file may or may not be indexed for information searching purposes. Information stored in data store 152 can also be optionally encrypted for added security.

The network 140 can include components capable of conveying digital content encoded within carrier waves. The content can be contained within analog or digital signals and conveyed through data or voice channels and can be conveyed over a personal area network (PAN) or a wide area network (WAN). The network 140 can include local components and data pathways necessary for communications to be exchanged among computing device components and between integrated device components and peripheral devices. The network 140 can also include network equipment, such as routers, data lines, hubs, and intermediary servers which together form a packet-based network, such as the Internet or an intranet. The network 140 can further include circuit-based communication components and mobile communication components, such as telephony switches, modems, cellular communication towers, and the like. The network 140 can include line based and/or wireless communication pathways.

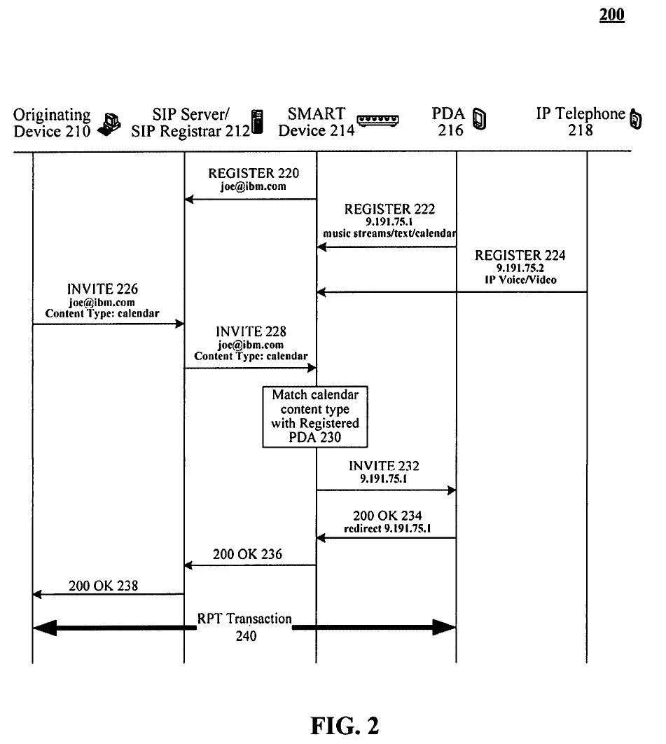

FIG. 2 is a flow diagram 200 illustrating use of a SMART device to route incoming messages based on content type in accordance with an embodiment of the inventive arrangements disclosed herein. The flow of diagram 200 can occur in a context of system 100 or similar IP based communication system. In diagram 200, messages are conveyed among an originating device 210, an SIP server 212, a SMART device 214, a personal data assistant (PDA) 216, and an IP telephone 218.

Initially, the SMART device 214 can register 220 with the SIP server 212 using a unique identifier (address) associated with the SMART device 214. As shown, the address of device 214 can be “joe@ibm.com.” The PDA 216 and the IP telephone 218 can each register 222, 224 with the SMART device 214. When registering, each device 216, 218 can specify a type of content that it is to be handled by that device. PDA 216 having an address of 9.191.75.1 can register 222 for music streams, text, and calendar communications. The IP telephone 218 having an address of 9.191.75.2 can register for IP voice communication and video communications.

After registration 220-224 occurs, an INVITE 226 message can be conveyed from the originating device to the SIP server 212. The message 226 can be directed to joe@ibm.com and can be for a calendar information exchange, which is a Real Time Protocol (RTP) communication. The SIP server 212 can forward the INVITE 228 to the SMART device 214. The smart device 214 can match 230 a calendar content type with registered devices and determine that the PDA 216 is to receive the message. The message is then redirected 232 by the SMART device 214 to the PDA 216. The PDA 216 can accept 234 the request by conveying a 200 OK message to the SMART device 214. The SMART device 214 can send a 200 OK 236 to the SIP server 212, which sends a 200 OK message 238 to the originating device 210. The RTP transaction 240 can be responsively established between the originating device 210 and the PDA 216.

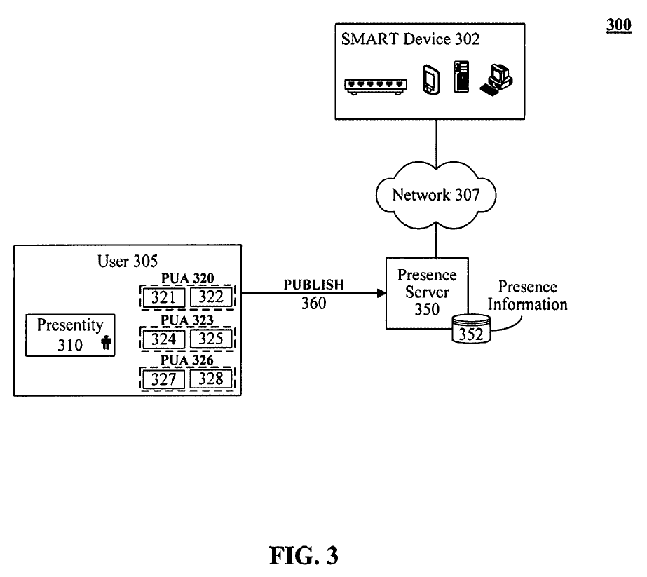

FIG. 3 is a schematic diagram illustrating a system 300 for automatically routing SIP communications based on the end-user location via proximity detection in accordance with the embodiment of inventive arrangements disclosed herein. System 300 represents an embodiment of system 100, where open standards are used to maintain presence data concerning a user 305. This presence information can be used by a SMART device 302 to selectively route or forward incoming SIP communications based upon a user's 305 location. System 300 illustrates that the SMART device 302 can receive information from remote sources, which it uses to evaluate routing conditions. Routing based on user location is illustrated for convenience and remotely received information can relate to any condition used by the SMART device 302.

In system 300, a presence server 350 can maintain presence information 352 related to user 305 in a data store 352. This presence information can be accessed by SMART device 302. User 305 can be referred to as a presentity 310. The presentity 310 can utilize one or more presence user agents (PUAs) 320, 323, 326. Each PUA 320, 323, 326 can be a communication device capable of publishing 360 presence information to the presence server 350. Each PUA 320, 323, 326 can include a location detector 321, 324, 327 and a communication component 322, 325, 328. The location detector 321, 324, 327 can detect a geographic location of the user 305. The communication component 322, 325, 328 can convey information to the presence server 350.

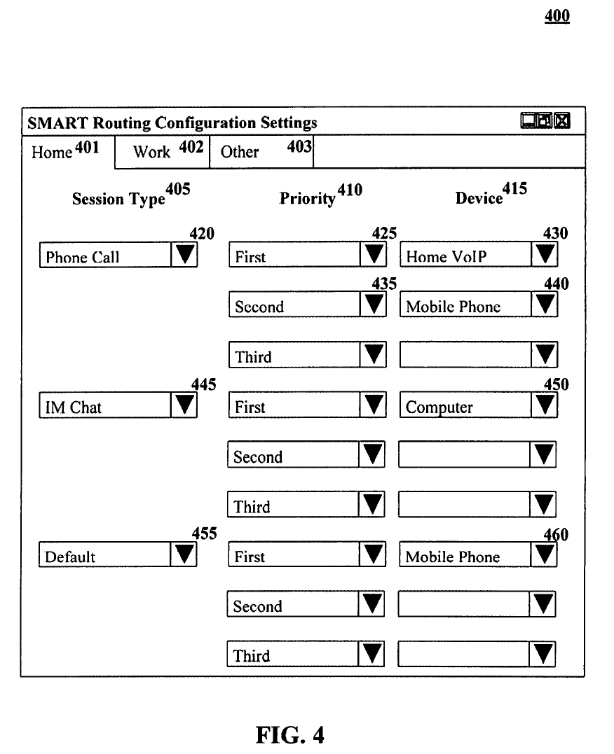

FIG. 4 is a schematic diagram illustrating an interface 400 that can be used to manage preferred routing settings of a SMART device in accordance with an embodiment of the inventive arrangements disclosed herein. In one embodiment, the SMART device can use the interface 400 which can be the device 110 of system 100. Elements and arrangements shown in interface 400 are for illustrative purposes only and the invention is not to be construed as limited in this regard. For example, interface 400 establishes a set of location based profiles. In a different embodiment, the profiles can be based upon communication type or any other definable condition.

Interface 400 can include a set of tabs 401-403 used to access different profiles, which can be established for different locations. Each profile can hold separate settings for automatic routing depending on a user's location when a message is received by the SMART device. In one embodiment, the profiles can be switched from one to another as a location of a user to whom a call is intended changes. For example, a profile associated with tab 401 can be used when a user is proximate to their home. A profile associated with tab 402 can be used when a user is proximate to a work location. A profile associated with tab 403 can be used when a user is neither at home or at work.

Each profile can establish different routing preferences for different types of incoming communications. The preferences of each profile can be modified by an authorized user. As shown, a session type 405 can be used to denote selection of the SIP content type for the routing preferences. Values for session type 405 can include a phone call communication type 420, an Instant Messaging (IM) communication type 445, a default communication type 455, and the like.

Additionally, for each type of incoming communication, a handling order can be established for one or more devices. That is, an incoming communication can initially be routed to a device 415 having a first priority 410, then to a device 415 having a second priority 410 should the first device be unavailable, then a device 415 having a third priority 410, and so forth. Accordingly, a phone call 420 can initially (425) be routed to a home VoIP 430 device, when the associated user is at home 401. If the user fails to pick-up the home VoIP device 430 (situation 435), the phone call 420 can be routed by the SMART device to a designated mobile phone 440. Shown settings of interface 400 indicate that IM chat 445 communications are to be routed to a computer 450 and that default communications 455 are to be routed to a mobile phone 460. Each of the devices 415 can be associated with a URI or address registered in the SMART device and can be used as an endpoint for an SIP communication.

It should be noted that SMART routing is not limited by priority (410) and that other configuration options are contemplated. For example, instead of routing to multiple devices based upon a predetermined order of preference, the SMART device can operate in a manner similar to an SIP server. That is, the SMART device can forward SIP invite messages to multiple devices at the same time, any of which can be used to handle an incoming SIP communication.

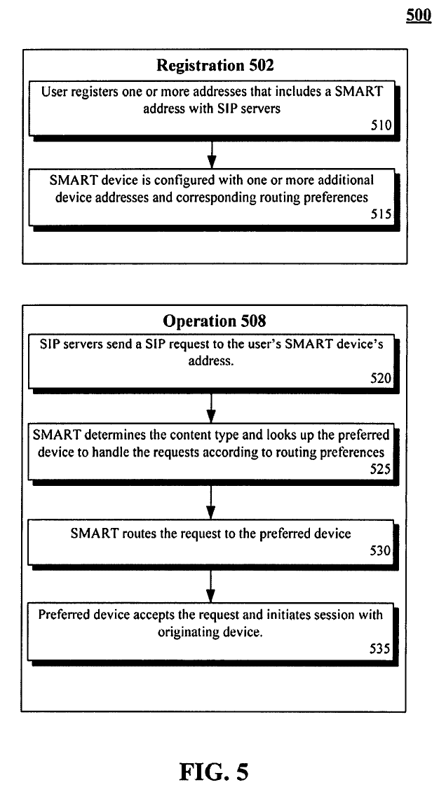

FIG. 5 is a flow chart of a method 500 of automatically routing SIP communications in accordance with an embodiment of the inventive arrangements disclosed herein. Method 500 can be performed in context of system 100 or in a context of any other system that enables a SMART device to route SIP communications. As illustrated, method 500 can include a registration process 502 and operation process 508.

The registration process 502 can begin in step 510, where a user registers one or more SIP enabled addresses that includes a SMART address with a registrar server. In step 515, the SMART device is configured with one or more additional device addresses and corresponding routing preferences. That is, routing preferences for incoming communications can be established within the SMART device, and SMART routing options can be activated.

The operation process 508 can begin in step 520, where the SIP servers send an SIP request to the user's SMART device's address. In step 525, SMART determines the content type of the SIP message and looks up the preferred device to handle the request according to the routing preference. In step 530, SMART routes the request to the preferred device. In step 535, the preferred device accepts the request and initiates session with originating device. All further communications are continued between the originating device and the preferred device and operation 508 ends.

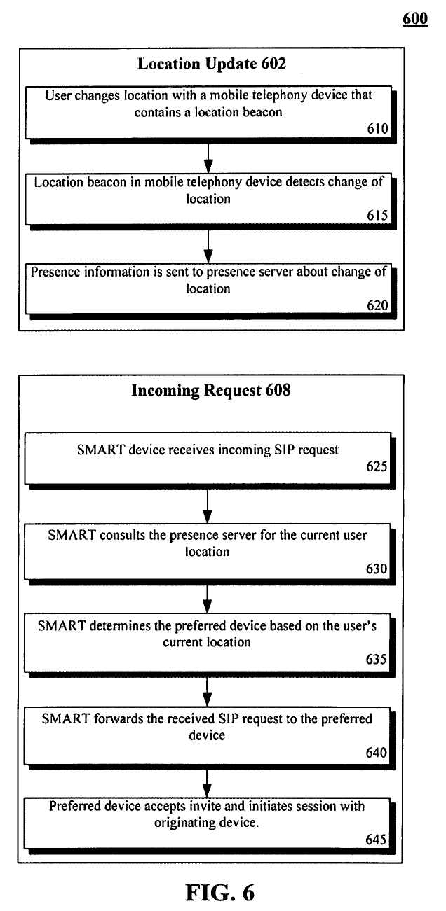

FIG. 6 is a flow chart of a method 600 of automatically routing SIP communications using a SMART device in accordance with an embodiment of the inventive arrangements disclosed herein. The method 600 can be performed in the context of system 100 or in a context of any other system that enables a SMART device to route SIP communications. As illustrated, method 600 can include a location update process 602 and a request handling process 608. The method 600 assumes a presence server is used to track a user's location and that a SMART device receives presence information used for routing from the presence server. Method 600 can be easily modified for handling dynamic conditions other than user location, which is used to illustrate a concept of routing based upon dynamic conditions.

The location update process can begin in step 610, where a user carrying a GPS equipped mobile telephony device (e.g., PUA) can move from one geographical location to another. In step 615, the change of location can be detected by the device. In step 620, presence information about the change of location can be sent to the presence server.

The request handling process 608 can being in step 625, where a SMART device can receive an incoming SIP communication request. In step 630, the SMART device can query a presence server for the user's current location. In step 635, SMART device can receive the user's current location from the presence server. The SMART device can activate a profile associated with the user's location and can determine how the received SIP message should be handled and where the SIP message should be routed (if anywhere). In step 640, the SMART device can forward the SIP message to a preferred handling device. In step 645, the preferred device can accept the SIP message and can engage in a communication session with a communication originating device.

The present invention may be realized in hardware, software, or a combination of hardware and software. The present invention may be realized in a centralized fashion in one computer system or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A method for communicating in an Internet protocol (IP) based system comprising a registrar server, said method comprising:
registering a primary address of a primary device with a registrar server, wherein the primary device comprises a routing engine, and wherein the registrar server is part of an IP based communication system;
maintaining a set of user configurable routing characteristics in a data store accessible by the primary device, which is used by a routing engine;
registering at least one auxiliary address of at least one auxiliary device with the primary device, which results in the auxiliary address being added to the data store accessible by the primary device; and
receiving a communication request directed from an originating device to the primary device, which the SIP server routes to the primary device based upon the registered primary address; and
upon receiving the routed communication request, the routing engine of the primary device forwarding the communication request to said at least one auxiliary device based upon the registered auxiliary address and the maintained routing characteristics.

2. The method of claim 1, wherein the at least one auxiliary device comprises a plurality of auxiliary devices, wherein the routing characteristics specify different ones of the auxiliary devices depending upon a type of communication being routed by the routing engine.

3. The method of claim 2, wherein the types of communication used to determine routing by the routing engine comprise a real-time Voice over IP (VoIP) communication, a text exchange communication, and a multimedia distribution communication.

4. The method of claim 1, wherein the primary device is an end-user communication device able to conduct SIP based communications with the originating device.

5. The method of claim 1, wherein said steps of claim 1 are steps performed automatically by at least one machine in accordance with at least one computer program having a plurality of code sections that are executable by the at least one machine, said at least one computer program being stored in a machine readable medium.

6. A Session Initiation Protocol (SIP) Message Automatic Routing Technique (SMART) device comprising:
a unique identifier used by an SIP based communication server as a communication endpoint; and
a SMART engine configured to forward received SIP messages to at least one other communication device in a manner transparent to the SIP based communication server.

7. The device of claim 6, wherein the unique identifier is an identifier to which an SIP server routes SIP communication requests, and wherein the forwarding performed by the SMART device occurs in a manner transparent to the SIP server.

8. The device of claim 6, further comprising:
a user configurable routing table used by the SMART engine to define a set of communication devices to which the SMART engine forwards SIP messages.

9. The device of claim 8, further comprising:
a plurality of configurable forwarding preferences that define which communication device is to be forwarded the SIP messages by the SMART device depending upon current values of a set of variable conditions.

10. The device of claim 9, wherein one of the variable conditions is communication type, wherein the configurable forwarding preferences specify that the SMART engine is to forward SIP messages to different communication devices depending on a type of communication.

11. The device of claim 10, wherein the type of communication comprises at least two of Internet telephony communications, multimedia distribution communications, multimedia conference communications, and text exchange communications, wherein text exchange communications comprise at least one of Instant Messaging communications, online chat communications, and text messaging communications.

12. The device of claim 6, wherein the SMART device is a consumer electronic device.

13. The device of claim 6, wherein the SMART device is at least one of a mobile telephone, a mobile emailing device, and an SIP telephone.

14. The device of claim 6, further comprising:
a communication interface configured to permit an end user to utilize the SMART device as a communication device for SIP based communications.

15. The device of claim 14, wherein the SIP based communications supported by the communication interface comprise at least one of Internet telephony communications, multimedia distribution communications, multimedia conference communications, and text exchange communications, wherein text exchange communications comprise at least one of Instant Messaging communications, online chat communications, and text messaging communications.

16. The device of claim 14, wherein the SIP based communications supported by the communication interface comprise at least three of Internet telephony communications, multimedia distribution communications, multimedia conference communications, and text exchange communications, wherein text exchange communications comprise at least one of Instant Messaging communications, online chat communications, and text messaging communications.

17. A Session Initiation Protocol (SIP) based communication system comprising:
a communication originating device configured to originate an SIP communication;
an SIP server configured to receive SIP communication origination messages, to match these origination messages to at least one address associated with an SIP enabled device, wherein one of the at least one addresses corresponds to an SIP Message Automatic Routing Technique (SMART) device;
the SMART device configured to receive SIP requests from the SIP server and to route each of these SIP requests to other SIP enabled devices associated with device addresses in accordance with a set of deterministic conditions and configurable routing preferences, wherein one of the other SIP enabled devices and one of the device addresses corresponds to a communication receiving device; and
a communication receiving device configured to receive an SIP request routed to the receiving device by the SMART device, from the SIP server, responsive to a communication request from the communication originating device, wherein when the communication receiving device accepts the received SIP request, an SIP based communication is established between the communication receiving device and the communication originating device.

18. The system of claim 17, wherein the SMART device is a computing device able to conduct SIP based communications with other communication devices.

19. The system of claim 17, wherein the routing preferences and devices to which communications are routed by the SMART device are end-user configurable, and wherein the routing performed by the SMART device is transparent to the SIP server.

20. The system of claim 17, wherein at least one of the configurable routing preferences is for specifying communication type, wherein different incoming messages associated with different communication types are routed by the SMART device to different communication receiving devices.
